(19) United States
(12) Patent Application Publication
(10) Pub. No.: US 2009/0114089 A1
(43) Pub. Date: May 7, 2009

(54) Microporous Aluminophosphate Molecular Sieve Membranes for Highly Selective Separations

(76) Inventors: Chunqing Liu, Schaumburg, IL (US); Stephen T. Wilson, Libertyville, IL (US); David A. Lesch, Hoffman Estates, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/934,200

(22) Filed: Nov. 2, 2007

(51) Int. Cl. B01J 20/28; B01D 37/00; B05D 5/00; C01B 25/36; B01D 53/22

(52) U.S. Cl. 95/45; 210/767; 423/305; 427/226; 427/372.2; 502/4

(57) ABSTRACT

The present invention discloses microporous aluminophosphate (AlPO₄) molecular sieve membranes and methods for making and using the same. The microporous AlPO₄ molecular sieve membranes, particularly small pore microporous AlPO-14 and AlPO-18 molecular sieve membranes, are prepared by three different methods, including in-situ crystallization of a layer of AlPO₄ molecular sieve crystals on a porous membrane support, coating a layer of polymer-bound AlPO₄ molecular sieve crystals on a porous membrane support, and a seeding method by in-situ crystallization of a continuous second layer of AlPO₄ molecular sieve crystals on a seed layer of AlPO₄ molecular sieve crystals supported on a porous membrane support. The microporous AlPO₄ molecular sieve membranes have superior thermal and chemical stability, good erosion resistance, high CO₂ plasticization resistance, and significantly improved selectivity over polymer membranes for gas and liquid separations, including carbon dioxide/methane (CO₂/CH₄), carbon dioxide/nitrogen (CO₂/N₂), and hydrogen/methane (H₂/CH₄) separations.

### BACKGROUND OF THE INVENTION

This invention pertains to novel high selectivity microporous aluminophosphate (AlPO₄) molecular sieve membranes. More particularly, the invention pertains to methods of making and using these microporous AlPO₄ molecular sieve membranes.

Gas separation processes with membranes have undergone a major evolution since the introduction of the first membrane-based industrial hydrogen separation process about two decades ago. The design of new materials and efficient methods will further advance membrane gas separation processes within the next decade.

The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve the separation properties of polymer membranes; current polymeric membrane materials have seemingly reached a limit in the trade-off between productivity and selectivity. For example, many polyimide and polyetherimide glassy polymers, such as Ultem® 1000 polyetherimide, made by GE Plastics, Pittsfield, Mass., have much higher intrinsic CO₂/CH₄ selectivities (α_{CO2/CH4}) (˜30 at 50° C. and 690 kPa (100 psig) pure gas tests) than that of cellulose acetate (˜22), which are more attractive for practical gas separation applications. These polymers, however, do not have levels of permeability attractive for commercialization compared to current commercial cellulose acetate membrane products, in agreement with the trade-off relationship reported by Robeson. In addition, gas separation processes based on glassy polymer membranes frequently suffer from plasticization of the stiff polymer matrix by the sorbed penetrant molecules such as CO₂ or C₃H₆. Plasticization of the polymer represented by the membrane structure swelling and a significant increase in the permeabilities of all components in the feed occurs above the plasticization pressure when the feed gas mixture contains condensable gases and therefore decreases selectivity.

Inorganic microporous molecular sieve membranes such as zeolite membranes have the potential for separation of gases under conditions where polymeric membranes cannot be used by taking advantages of their superior thermal and chemical stability, good erosion resistance, and high plasticization resistance to condensable gases.

Microporous molecular sieves are inorganic microporous crystalline materials with pores of a well-defined size ranging from about 0.2 to 2 nm. Zeolites are a subclass of microporous molecular sieves based on an aluminosilicate composition. Non-zeolitic molecular sieves are based on other compositions such as aluminophosphates, silicoaluminophosphates, and silica. Molecular sieves of different chemical compositions can have the same or different framework structures. Representative examples of microporous molecular sieves are small-pore molecular sieves such as SAPO-34, Si-DDR, UZM-9, AlPO-14, AlPO-34, AlPO-17, SSZ-62, SSZ-13, AlPO-18, LTA, UZM-25, ERS-12, CDS-1, MCM-65, MCM-47, 4A, 5A, UZM-5, UZM-9, AlPO-34, SAPO-44, SAPO-47, SAPO-17, CVX-7, SAPO-35, SAPO-56, AlPO-52, SAPO-43, medium-pore molecular sieves such as silicalite-1, and large-pore molecular sieves such as NaX, NaY, and CaY. Membranes made from these microporous molecular sieve materials provide separation properties mainly based on molecular sieving and/or competitive adsorption mechanism. Separation with microporous molecular sieve membranes is mainly based on competitive adsorption when the pores of large- and medium-pore microporous molecular sieves are much larger than the molecules to be separated. Separation with microporous molecular sieve membranes is mainly based on molecular sieving or both molecular sieving and competitive adsorption when the pores are smaller or similar to one molecule but are larger than other molecules in a mixture to be separated.

A majority of inorganic microporous molecular sieve membranes supported on porous membrane support reported to date are made from MFI, LTA, FAU or MOR. LTA zeolites have pores in the range of 0.3-0.5 nm, and are able to distinguish small molecules such as H₂ and N₂. Guan et al. reported a H₂/N₂ ideal separation factor of 7.1 for a Na⁺-type LTA zeolite membrane and improved the value to 7.5 by ion-exchange with K⁺ (see Guan et al., SEPARATION SCIENCE AND TECHNOLOGY, 2001, 36, 2233). The pores of MFI zeolites are approximately 0.5-0.6 nm, and are larger than CO₂, CH₄, and N₂. Lovallo et al. obtained a selectivity of about 10 for CO₂/CH₄ separation using a high-silica MFI membrane at 393° K. (see Lovallo et al., AICHE JOURNAL, 1998, 44, 1903). The pores of FAU zeolite are approximately 0.78 nm in size, and are larger than the molecular sizes of H₂ and N₂. High separation factors have been reported for CO₂/N₂ mixtures using FAU-type zeolite membranes. Permeation and adsorption experiments indicate that the high separation factors can be explained by competitive adsorption of CO₂ and N₂.

In recent years, some small-pore microporous molecular sieve membranes such as zeolite T (0.41 nm pore diameter), DDR (0.36×0.44 nm), and SAPO-34 (0.38 nm) have been prepared. These membranes possess pores that are similar in size to CH₄ but larger than CO₂ and have high CO₂/CH₄ selectivities due to a combination of differences in diffusivity and competitive adsorption. For example, a DDR type zeolite membrane has shown much higher CO₂ permeability and CO₂/CH₄ selectivity compared to polymer membranes. See Tomita et al., Microporous and Mesoporous Materials, 2004, 68, 71; Nakayama, US 2004/0173094. SAPO-34 molecular sieve membranes showed improved selectivity for separation of certain gas mixtures, including mixtures of CO₂ and CH₄. See Li et al., ADVANCED MATERIALS, 2006, 18, 2601; Falconer et al., US 2005/0204916.

There remains a need for improved molecular sieve membranes that provide improved selectivity for separations. Previous to the present invention, pure microporous aluminophosphate (AlPO₄) molecular sieve membranes such as AlPO-14 and AlPO-18 membranes have not been reported. The present invention discloses novel microporous aluminophosphate (AlPO₄) molecular sieve membranes and methods for making and using the same.

### DETAILED DESCRIPTION OF THE INVENTION

The present invention discloses novel microporous aluminophosphate (AlPO₄) molecular sieve membranes and methods for making and using these molecular sieve membranes. The microporous AlPO₄ molecular sieve membranes, including small pore microporous AlPO-14 and AlPO-18 molecular sieve membranes, can be prepared by at least three different methods, including in-situ crystallization of one layer or multi layers of AlPO₄ molecular sieve crystals on a porous membrane support, coating a layer of polymer-bound AlPO₄ molecular sieve crystals on a porous membrane support, and a seeding method by in-situ crystallization of one continuous layer or multi layers of AlPO₄ molecular sieve crystals on a seed layer of AlPO₄ molecular sieve crystals supported on a porous membrane support.

The first method of preparation in accordance with this invention provides for making high selectivity microporous aluminophosphate (AlPO₄) molecular sieve membrane by in-situ crystallization of one layer or multi layers of AlPO₄ molecular sieve crystals on a porous membrane support comprising the steps of providing a porous membrane support having an average pore size of 0.1 μm or greater than 0.1 μm; synthesizing an aqueous AlPO₄-forming gel comprising an organic structure-directing template or a mixture of two or more organic structure-directing templates; aging the AlPO₄-forming gel to produce an aged AlPO₄-forming gel; contacting at least one surface of the porous membrane support with the aged AlPO₄-forming gel; heating the porous membrane support and the aged AlPO₄-forming gel to form a layer of AlPO₄ crystals on at least one surface of the porous membrane support or inside the pores of the porous membrane support to produce a template-containing AlPO₄ molecular sieve membrane; and calcining the resulting template-containing AlPO₄ molecular sieve membrane to remove the organic structure-directing template(s) and to form a layer of template-free microporous AlPO₄ molecular sieve crystals on the porous membrane support. In some cases to further improve selectivity but not change or damage the membrane, or cause the membrane to lose performance with time, multiple layers of template-free microporous AlPO₄ molecular sieve crystals are formed on the porous membrane support by contacting the template-containing AlPO₄ molecular sieve membrane with the aged AlPO₄-forming gel again followed by heating to form another layer of template-containing AlPO₄ membrane. This contacting and heating step may be repeated two or more times.

A second method for preparing high selectivity microporous aluminophosphate (AlPO₄) molecular sieve membranes is by coating a layer of polymer-bound AlPO₄ molecular sieve crystals on a porous membrane support in accordance with the following steps: Providing a porous membrane support having an average pore size of 0.1 μm or greater than 0.1 μm; providing template-free AlPO₄ molecular sieve crystal particles synthesized by a hydrothermal synthesis method; forming a slurry by dispersing the template-free AlPO₄ molecular sieve crystal particles in one solvent or a mixture of two or more solvents by ultrasonic mixing, mechanical stirring or a both ultrasonic mixing and mechanical stirring; dissolving one or more types polymers as a binder of the AlPO₄ molecular sieve particles in the slurry to form a stable polymer-bound AlPO₄ molecular sieve suspension; coating at least one surface of the porous membrane support with the stable polymer-bound AlPO₄ molecular sieve suspension; drying the polymer-bound AlPO₄ molecular sieve coating on the porous membrane support by heating to form high selectivity microporous AlPO₄ molecular sieve membrane. In some cases, a membrane post-treatment step can be added to improve selectivity but not change or damage the membrane, or cause the membrane to lose performance with time. The membrane post-treatment step can involve coating the top surface of the microporous AlPO₄ molecular sieve membrane with a thin layer of material such as a polysiloxane, a fluoro-polymer, a thermally curable silicone rubber, a high permeability microporous polymer, a high permeability polybenzoxazole polymer, or a UV radiation curable epoxy silicone.

A third method for preparing a high selectivity microporous aluminophosphate (AlPO₄) molecular sieve membrane by seeding including in-situ crystallization of a continuous second layer of AlPO₄ molecular sieve crystals on a seed layer of AlPO₄ molecular sieve crystals supported on a porous membrane support comprising the steps of: Providing a porous membrane support having an average pore size of 0.1 μm or greater than 0.1 μm; providing template-containing AlPO₄ molecular sieve seeds with an average particle size of ˜50 nm to 1 μm synthesized by a hydrothermal synthesis method or a microwave assisted hydrothermal synthesis method; dispersing the template-containing AlPO₄ molecular sieve seed particles in a solvent to prepare a colloidal solution of the AlPO₄ molecular sieve seed particles; coating a layer of the colloidal solution of the template-containing AlPO₄ molecular sieve seeds on at least one surface of the porous membrane support by immersing the porous membrane support in the colloidal solution of the AlPO₄ molecular sieve seed particles; drying the colloidal solution layer of the template-containing AlPO₄ molecular sieve seeds on the surface of the porous membrane support to form a seed layer of AlPO₄ molecular sieve crystals on the porous membrane support; synthesizing an aqueous AlPO₄-forming gel comprising an organic structure-directing template or a mixture of two or more organic structure-directing templates; aging the AlPO₄-forming gel to form an aged AlPO₄-forming gel; contacting the surface of the seed layer of AlPO₄ molecular sieve crystals supported on a porous membrane support with the aged AlPO₄-forming gel; heating the seeded porous membrane support and the aged AlPO₄-forming gel to form a continuous second layer of AlPO₄ molecular sieve crystals on the seed layer of AlPO₄ molecular sieve crystals supported on the porous membrane support; and calcining the resulting template-containing dual layer AlPO₄ molecular sieve membrane to remove the organic structure-directing template and form a dual layer template-free microporous AlPO₄ molecular sieve crystals on the porous membrane support. In some cases to further improve selectivity but not change or damage the membrane, or cause the membrane to lose performance with time, multiple layers of template-free microporous AlPO₄ molecular sieve crystals are formed on the porous membrane support by contacting the surface of the second layer of AlPO₄ molecular sieve crystals on the seed layer of AlPO₄ molecular sieve crystals supported on the porous membrane support with the aged AlPO₄-forming gel again followed by heating and repeating the contact and heating steps as desired.

The methods of the current invention for producing defect free high selectivity microporous AlPO₄ molecular sieve membranes are suitable for large scale membrane production. The microporous AlPO₄ molecular sieve used for the preparation of the microporous AlPO₄ molecular sieve membrane in this invention has selectivity significantly higher than any polymer membranes for separations of gases. The microporous AlPO₄ molecular sieve used for the preparation of the microporous AlPO₄ molecular sieve membrane in the current invention is selected from the group consisting of AlPO-18, AlPO-14, AlPO-52, AlPO-53, AlPO-5, AlPO-34, AlPO-31, AlPO-17, AlPO-11, AlPO-41, AlPO-25, AlPO-21, AlPO-22, and mixtures thereof.

The polymer that serves as a binder of the AlPO₄ molecular sieve particles is a glassy polymer such as a polyimide, polyethersulfone, polybenzoxazole, microporous polymer, or a mixture thereof.

The microporous AlPO₄ molecular sieve membranes in the form of a disk, tube, or hollow fiber fabricated by the methods described in the current invention have superior thermal and chemical stability, good erosion resistance, high CO₂ plasticization resistance, and significantly improved selectivity over polymer membranes for gas and liquid separations, including carbon dioxide/methane (CO₂/CH₄), carbon dioxide/nitrogen (CO₂/N₂), and hydrogen/methane (H₂/CH₄) separations.

The invention provides a process for separating at least one gas or liquid from a mixture of gases or liquids using the microporous AlPO₄ molecular sieve membranes described herein. This process for separating gases or liquids comprises: Providing a microporous AlPO₄ molecular sieve membrane which is permeable to said at least one gas or liquid; contacting the mixture on one side of the microporous AlPO₄ molecular sieve membrane to cause said at least one gas or liquid to permeate the microporous AlPO₄ molecular sieve membrane; and removing from the opposite side of the membrane a permeate gas or liquid composition comprising a portion of said at least one gas or liquid which permeated said membrane.

The microporous AlPO₄ molecular sieve membranes of the present invention are useful for liquid separations such as deep desulfurization of gasoline and diesel fuels, ethanol/water separations, and pervaporation dehydration of aqueous/organic mixtures, as well as for a variety of gas and vapor separations such as CO₂/CH₄, CO₂/N₂, H₂/CH₄, O₂/N₂, olefin/paraffin such as propylene/propane, iso/normal paraffins, polar molecules such as H₂O, H₂S, and NH₃/mixtures with CH₄, N₂, H₂, and other light gases separations.

### EXAMPLES

The following examples are provided to illustrate one or more preferred embodiments of the invention, but are not limited embodiments thereof. Numerous variations can be made to the following examples that lie within the scope of the invention.

### Example 1

A “control” poly(3,3′,4,4′-diphenylsulfone tetracarboxylic dianhydride-3,3′,5,5′-tetramethyl-4,4′-methylene dianiline) (poly(DSDA-TMMDA)) polymer membrane was prepared as a comparative example 6.0 g of poly(DSDA-TMMDA) polyimide polymer was dissolved in a solvent mixture of 14.0 g of N-methylpyrrolidone (NMP) and 20.6 g of 1,3-dioxolane by mechanical stirring for 3 hours to form a homogeneous casting dope. The resulting homogeneous casting dope was allowed to degas overnight. A “control” poly(DSDA-TMMDA)-PES polymer membrane was prepared from the bubble free casting dope on a clean glass plate using a doctor knife with a 20-mil gap. The membrane together with the glass plate was then put into a vacuum oven. The solvents were removed by slowly increasing the vacuum and the temperature of the vacuum oven. Finally, the membrane was detached from the glass plate and dried at 200° C. under vacuum for at least 48 hours to completely remove the residual solvents to form the “control” poly(DSDA-TMMDA) polymer membrane (abbreviated as poly(DSDA-TMMDA) membrane in Tables 1 and 2).

### Example 2

An AlPO-14 microporous molecular sieve membrane was prepared. An AlPO-14 microporous molecular sieve membrane containing polymers as the binder for AlPO-14 particles was prepared as follows: 4.2 g of calcined template-free AlPO-14 molecular sieves were dispersed in a mixture of 15.0 g of NMP and 22.2 g of 1,3-dioxolane by mechanical stirring and ultrasonication for 1 hour to form a slurry. Then 1.4 g of PES was added to functionalize AlPO-14 molecular sieves in the slurry. The slurry was stirred for at least 1 hour to completely dissolve PES polymer and functionalize the surface of AlPO-14. After that, 4.6 g of poly(DSDA-TMMDA) polyimide polymer was added to the slurry and the resulting mixture was stirred for another 3 hours to form a stable coating dope containing 70 wt-% of dispersed AlPO-14 molecular sieves (weight ratio of AlPO-14 to poly(DSDA-TMMDA) and PES is 70:100). The stable coating dope was allowed to degas overnight.

An AlPO-14 molecular sieve membrane was prepared by casting the bubble free coating dope on a clean glass plate using a doctor knife with a 30-mil gap. The film together with the glass plate was then put into a vacuum oven. The solvents were removed by slowly increasing the vacuum and the temperature of the vacuum oven. Finally, the membrane was detached from the glass plate and was dried at 200° C. under vacuum for at least 48 hours to completely remove the residual solvents to form AlPO-14 molecular sieve membrane (abbreviated as AlPO-14 membrane in Tables 1 and 2).

### Example 3

An AlPO-18 microporous molecular sieve membrane was prepared by a coating method. An AlPO-18 microporous molecular sieve membrane containing polymers as the binder for AlPO-18 particles was prepared as follows: 4.2 g of AlPO-18 molecular sieves were dispersed in a mixture of 15.0 g of NMP and 22.2 g of 1,3-dioxolane by mechanical stirring and ultrasonication for 1 hour to form a slurry. Then 1.4 g of PES was added to functionalize AlPO-18 molecular sieves in the slurry. The slurry was stirred for at least 1 hour to completely dissolve PES polymer and functionalize the surface of AlPO-18. After that, 4.6 g of poly(DSDA-TMMDA) polyimide polymer was added to the slurry and the resulting mixture was stirred for another 3 hours to form a stable coating dope containing 70 wt-% of dispersed AlPO-18 molecular sieves (weight ratio of AlPO-18 to poly(DSDA-TMMDA) and PES is 70:100). The stable coating dope was allowed to degas overnight.

An AlPO-18 molecular sieve membrane was prepared on a non-woven fabric porous membrane support by coating the bubble free coating dope using a doctor knife with a 10-mil gap. The film together with the fabric substrate was then put into a vacuum oven. The solvents were removed by slowly increasing the vacuum and the temperature of the vacuum oven. Finally, the membrane was dried at 200° C. under vacuum for at least 48 hours to completely remove the residual solvents to form AlPO-18 molecular sieve membrane (abbreviated as AlPO-18 membrane).

### Example 4

An AlPO-18 microporous molecular sieve membrane was prepared on a porous stainless steel tube by an in-situ crystallization method. An AlPO-18 microporous molecular sieve membrane was synthesized by in-situ crystallization on a porous stainless steel tube (0.8 μm pores, Pall Corporation, USA). Before the synthesis of AlPO-18 microporous molecular sieve membrane, the porous stainless steel tube was boiled in purified water for 3 hours and dried at 100° C. under vacuum for 30 minutes.

A clear aqueous AlPO-18-forming solution comprising an organic structure-directing template, tetraethylammonium hydroxide (TEAOH), with molar composition of 6.32TEAOH:1.0Al₂O₃:3.16P₂O₅:186H₂O was synthesized by mixing aluminum isopropoxide (Aldrich), TEAOH (35 wt-%, Aldrich) and water under vigorous stirring for 1 hour. Then phosphoric acid (85 wt-%, Aldrich) was added very slowly in a drop-wise fashion. The resulting mixture was stirred for 2 hours at ambient temperature in order to obtain a clear aluminophosphate AlPO-18-forming solution. The clear solution was filtered with a 450 nm PTFE filer.

The stainless steel tube with its outside wrapped in Teflon® tape was directly placed vertically in a Teflon® tube in an autoclave. The Teflon® tube was then filled with the clear aqueous AlPO-18-forming solution to cover the end of the stainless steel tube. Typically, the solution level was approximately 10 mm above the upper end of the stainless tube. Hydrothermal synthesis was carried out for about 20 hours at 150° C. After synthesis, the membrane was washed with purified water at 24° C. and dried at 100° C. in an oven for about 10 minutes. A second synthesis layer was applied using the same procedure, but the tube was inverted to obtain a more uniform layer and a second AlPO-18-forming gel with different aluminum and phosphorus composition was used. The second AlPO-18-forming gel with a molar composition of 1.0 TEAOH:1.0Al₂O₃:1.0P₂O₅:40H₂O was synthesized by mixing Versal 250 (aluminum source) and water for 0.5 hour first, then adding phosphoric acid (85 wt-%, Aldrich) slowly under stirring and stirring for 1 hour. Finally, TEAOH (35 wt-%, Aldrich) was added very slowly in a drop-wise fashion and the resulting mixture was stirred for at least 24 hours at ambient temperature to age the AlPO-18-forming gel. The third and fourth synthesis layers (if needed) were prepared using the same procedure as the second layer. The membrane was calcined in air at 390° C. for 10 hours to remove the TEAOH template from the AlPO-18 framework. The heating and cooling rates were 0.6 and 0.9° C. min⁻¹, respectively.

### Example 5

An AlPO-18 microporous molecular sieve membrane was prepared on a porous ceramic disk by an in-situ crystallization method. An AlPO-18 microporous molecular sieve membrane was synthesized by in-situ crystallization on a porous inorganic ceramic membrane disk (0.18 μm pores, cat. no.: MF disc 180 nm dia 39 T2.0 G, ECO Ceramics B.V., The Netherlands). Before the synthesis of AlPO-18 microporous molecular sieve membrane, the porous inorganic ceramic membrane disk was boiled in purified water for 3 hours and dried at 100° C. under vacuum for 30 minutes.

A clear aqueous AlPO-18-forming solution comprising an organic structure-directing template, tetraethylammonium hydroxide (TEAOH), with molar composition of 6.32TEAOH:1.0Al₂O₃:3.16P₂O₅:186H₂O was synthesized by mixing aluminum isopropoxide (Aldrich), TEAOH (35 wt-%, Aldrich) and water under vigorous stirring for 1 hour. Then phosphoric acid (85 wt-%, Aldrich) was added very slowly in a drop-wise fashion. The resulting mixture was stirred for 2 hours at ambient temperature in order to obtain a clear aluminophosphate AlPO-18-forming solution. The clear solution was filtered with a 450 nm PTFE filer.

The porous inorganic ceramic membrane disk was placed vertically in a Teflon® tube in an autoclave. The Teflon® tube was then filled with the clear aqueous AlPO-18-forming solution to cover the top edge of the disk. Hydrothermal synthesis was carried out for about 20 hours at 150° C. After synthesis, the membrane was washed with purified water at 24° C. and dried at 100° K. in an oven for about 10 minutes. A second synthesis layer was applied using the same procedure, but the disk was inverted to obtain a more uniform layer and a second AlPO-18-forming gel with different aluminum and phosphorus composition was used. The second AlPO-18-forming gel with a molar composition of 1.0 TEAOH:1.0Al₂O₃:1.0P₂O₅:40H₂O was synthesized by mixing Versal 250 (aluminum source) and water for 0.5 hour first, then adding phosphoric acid (85 wt-%, Aldrich) slowly under stirring and stirring for 1 hour. Finally, TEAOH (35 wt-%, Aldrich) was added very slowly in a drop-wise fashion and the resulting mixture was stirred for at least 24 hours at ambient temperature to age the AlPO-18-forming gel. The third and fourth synthesis layers (if needed) were prepared using the same procedure as the second layer. The membrane was calcined in air at 390° C. for 10 hours to remove the TEAOH template from the AlPO-18 framework. The heating and cooling rates were 0.6 and 0.9° C. min⁻¹, respectively.

### Example 6

An AlPO-18 microporous molecular sieve membrane was prepared on a porous ceramic disk by a seeding method. An AlPO-18 microporous molecular sieve membrane was synthesized by in-situ crystallization on a porous inorganic ceramic membrane disk (0.18 μm pores, cat. no.: MF disc 180 nm dia 39 T2.0 G, ECO Ceramics B.V., The Netherlands). Before the synthesis of AlPO-18 microporous molecular sieve membrane, the porous inorganic ceramic membrane disk was boiled in purified water for 3 hours and dried at 100° C. under vacuum for 30 minutes.

A clear aqueous AlPO-18-forming solution comprising an organic structure-directing template, tetraethylammonium hydroxide (TEAOH), with molar composition of 6.32TEAOH:1.0Al₂O₃:3.16P₂O₅:186H₂O was synthesized by mixing aluminum isopropoxide (Aldrich), TEAOH (35 wt-%, Aldrich) and water under vigorous stirring for 1 hour. Then phosphoric acid (85 wt-%, Aldrich) was added very slowly in a drop-wise fashion. The resulting mixture was stirred for 2 hours at ambient temperature in order to obtain a clear aluminophosphate AlPO-18-forming solution. The clear solution was filtered with a 450 nm PTFE filer. The hydrothermal synthesis was carried out in a Teflon-lined autoclave at 150° C. for 20 hours. After the synthesis, the suspension containing nanosized AlPO-18 crystals was purified in a series of three steps consisting of high-speed centrifugation, removal of the mother liquor and re-dispersion in water using an ultrasonic bath.

The nanosized AlPO-18 crystals were re-dispersed in ethanol to obtain a concentration of the solid product of about 3 wt-% and used for the preparation of seed layer on the porous inorganic ceramic membrane disk (0.18 μm pores, cat. no.: MF disc 180 nm dia 39 T2.0 G, ECO Ceramics B.V., The Netherlands) via a spin coating or dip coating method. The uniform seeded porous inorganic ceramic membrane disk was placed vertically in a Teflon® tube in an autoclave. The Teflon® tube was then filled with an aged AlPO-18-forming gel to cover the top edge of the disk. Hydrothermal synthesis was carried out for about 20 hours at 150° C. The aged AlPO-18-forming gel with a molar composition of 1.0 TEAOH:1.0Al₂O₃:1.0P₂O₅:40H₂O was synthesized by mixing Versal 250 (aluminum source) and water for 0.5 hour first, then adding phosphoric acid (85 wt-%, Aldrich) slowly under stirring and stirring for 1 hour. Finally, TEAOH (35 wt-%, Aldrich) was added very slowly in a drop-wise fashion and the resulting mixture was stirred for at least 24 hours at ambient temperature to age the AlPO-18-forming gel. After the membrane was heated at 150° C., the membrane with a first layer of template-containing AlPO-18 crystals on the surface of the uniform seeded porous inorganic ceramic membrane disk was washed with purified water at 24° C. and dried at 100° C. in an oven for about 10 minutes. A second synthesis layer was applied using the same procedure, but the disk was inverted to obtain a more uniform layer. The third and fourth synthesis layers (if needed) were prepared using the same procedure as the first and second layers. The membrane was calcined in air at 390° C. for 10 hours to remove the TEAOH template from the AlPO-18 framework. The heating and cooling rates were 0.6 and 0.9° C. min⁻¹, respectively.

### Example 7

An AlPO-5 molecular sieve membrane was prepared on a porous α-alumina tube by a seeding method. A porous α-alumina tube membrane (1.2 μm pores, Pall Corporation, USA) was used as a membrane support. Both ends of the substrate were glazed to expose 2 cm in the middle portion, which was seeded as follows: First, template-containing nanosized AlPO-5 particles were synthesized. A suspension with the following chemical composition 1Al₂O₃:1.5P₂O₅:2TEAOH:80H₂O was hydrothermally (HT) treated under stirred condition at 150° C. for 20 hours. Aluminum isopropoxide (Aldrich), tetraethylammonium hydroxide (TEAOH, 35 wt-%, Aldrich) and DI water were mixed under 1000 rpm vigorous stirring for 1 hour and then the phosphoric acid (85 wt-%, Aldrich) was added very slowly in a drop-wise fashion in order to avoid the suspension to form dense gels. The resulted milky suspension mixture was stirred for 0.5 hour prior to transferring to a 0.6 L stirred reactor. The reactor was ramped over 4 hours to 150° C. and held at 150° C. for 20 hours under 250 rpm stirring. After the HT treatment, the resulted milky suspensions containing nanosized AlPO-5 crystals were purified by centrifugation in a series of three steps (10,000 rpm for 40 minutes) and thoroughly redispersed in water using an ultrasonic bath containing ice.

A pre-cleaned membrane support was immersed into this AlPO-5 suspension. The AlPO-5 suspension was slowly drawn out using a peristaltic pump so that the AlPO-5 seed particles attach to the support by electrostatic attraction and surface adhesion. The membrane support coated with AlPO-5 seeds was dried at ambient conditions and was secondary grown to form AlPO-5 membrane by HT synthesis using a precursor solution of molar composition 1Al₂O₃:1.5P₂O₅:2TEAOH:80H₂O. The mother liquor was prepared by dissolving aluminum isopropoxide (Aldrich) and TEAOH (35 wt-%, Aldrich) in DI water and mixing it with phosphoric acid (85 wt-%, Aldrich) under vigorous stirring at room temperature by adding phosphoric acid very slowly in a drop-wise fashion in order to avoid the suspension to form dense gels. The suspension was transferred to a Teflon-lined stainless steel autoclave and the dip-coated support membrane was introduced vertically. The autoclave was then heated in an air-oven at 150° C. for 20 hours. After the synthesis, the autoclave was cooled down to room temperature and the substrate was washed thoroughly with water, dried at 50° C. and tested for defects using permeation measurements. More AlPO-5 crystal layers were prepared using the same procedure as the second layer if the membrane with two AlPO-5 layers still has defects. The final AlPO-5 membrane was calcined at 550° C. (heating rate of 0.5° C./min) for 6 hours to remove the TEAOH templates occluded in the molecular sieve pores during synthesis.

### Example 8

An AlPO-14 microporous molecular sieve membrane was prepared on a porous ceramic disk by an in-situ crystallization method. An AlPO-14 microporous molecular sieve membrane was synthesized by in-situ crystallization on a porous inorganic ceramic membrane disk (0.18 μm pores, cat. no.: MF disc 180 nm dia 39 T2.0 G, ECO Ceramics B.V., The Netherlands). Before the synthesis of AlPO-14 microporous molecular sieve membrane, the porous inorganic ceramic membrane disk was boiled in purified water for 3 hours and dried at 100° C. under vacuum for 30 minutes.

An AlPO-14-forming synthesis gel comprising organic structure-directing templates, isopropylamine (iPrNH₂, Aldrich) and tetrabutylammonium hydroxide (TBAOH, 40 wt-% in water, Aldrich), with molar composition of 0.25 iPrNH₂:0.75 TBAOH:1.0 Al₂O₃:1.0P₂O₅:40H₂O was synthesized by mixing Versal 251 (aluminum source) in H₂O first, Then phosphoric acid (85 wt-%, Aldrich) was added very slowly in a drop-wise fashion under stirring. After that, a mixture of iPrNH₂ and TBAOH templates was added very slowly in a drop-wise fashion under stirring. The resulting mixture was stirred for at least 24 hours at room temperature to obtain an aged AlPO-14-forming gel.

The porous inorganic ceramic membrane disk was placed vertically in a Teflon® tube in an autoclave. The Teflon® tube was then filled with the aged AlPO-14-forming gel to cover the top edge of the disk. Hydrothermal synthesis was carried out for about 30 hours at 175° C. After synthesis, the membrane was washed with purified water at 24° C. and dried at 100° C. in an oven for about 10 minutes. A second synthesis layer was applied using the same procedure, but the disk was inverted to obtain a more uniform layer. The third and fourth synthesis layers (if needed) were prepared using the same procedure as the first and second layers. The membrane was calcined in air at 600° C. for 10 hours to remove the organic templates from the AlPO-14 framework. The heating and cooling rates were 0.6 and 0.9° C. min⁻¹, respectively.

### Example 9

The CO₂/CH₄ separation properties of “Control” poly(DSDA-TMMDA) polymer membrane prepared in Example 1 and AlPO-14 membrane prepared in Example 2 were determined. The permeabilities (P_{CO2} and P_{CH4}) and selectivity (α_{CO2/CH4}) of the “control” poly(DSDA-TMMDA) polymer membrane and AlPO-14 membrane containing poly(DSDA-TMMDA) and PES polymer binders were measured by pure gas measurements at 50° C. under about 690 kPa (100 psig) pressure. The results for CO₂/CH₄ separation are shown in Table 1.

It can be seen from Table 1 that the AlPO-14 membrane showed significantly improved selectivity and permeability over poly(DSDA-TMMDA) polymer membrane for CO₂/CH₄ separation. The AlPO-14 membrane (α_{CO2/CH3}=47.3 and P_{CO2}=52.0 barrers) showed simultaneous α_{CO2/CH4} increase by 76% and P_{CO2} increase by 117% compared to the “control” poly(DSDA-TMMDA) membrane (α_{CO2/CH4}=24.0 and P_{CO2}=26.9 barrers) for CO₂/CH₄ separation. These results demonstrate that the AlPO-14 molecular sieves in AlPO-14 membrane possessing micropores that are smaller or similar in size to CH₄ but larger than CO₂ have high CO₂/CH₄ selectivity due to a molecular sieving mechanism.

AlPO-14 membrane of the present invention showed significantly enhanced CO₂/CH₄ separation performance that far exceeded theoretical upper bounds for CO₂/CH₄ separation. These results indicate that the novel voids and defects free AlPO-14 membrane of the present invention is a very promising membrane candidates for the removal of CO₂ from natural gas or flue gas. The improved performance of AlPO-14 membrane over the “control” poly(DSDA-TMMDA) polymer membrane is attributed to the molecular sieving mechanism of AlPO-14 molecular sieves.

TABLE 1
Pure gas permeation test results of “Control” poly(DSDA-TMMDA)
polymer membrane and AlPO-14 membrane for CO₂/CH₄
separation^{a}

| | P_{CO2} | ΔP_{CO2} | | |
|---|---|---|---|---|
| Membrane | (Barrer) | (Barrer) | α_{CO2/CH4} | Δα_{CO2/CH4} |
| Poly(DSDA-TMMDA) | 24.0 | 0 | 26.9 | 0 |
| membrane | | | | |
| from Example 1 | | | | |
| AlPO-14 membrane | 52.0 | 117% | 47.3 | 76% |
| from Example 2 | | | | |

^{a}Tested at 50° C. under 690 kPa (100 psig) pure gas pressure.

### Example 10

The H₂/CH₄ separation properties of “Control” poly(DSDA-TMMDA) polymer membrane prepared in Example 1 and AlPO-14 membrane prepared in Example 2 were determined. The permeabilities (P_{H}_{₂} and P_{CH}_{₄}) and selectivity (α_{H}_{₂}_{/CH}_{₄}) of the “control” poly(DSDA-TMMDA) polymer membrane and AlPO-14 membrane were measured by pure gas measurements at 50° C. under about 690 kPa (100 psig) pressure using a dense film test unit. The results for H₂/CH₄ separation are shown in Table 2.

It can be seen from Table 2 that the AlPO-14 membrane showed significantly improved selectivity and permeability over poly(DSDA-TMMDA) polymer membrane for H₂/CH₄ separation. The AlPO-14 membrane (α_{H2/CH4}=133.2 and P_{H2}=146.5 barrers) showed simultaneous (α_{H2/CH4} increase by ˜90% and P_{H2} increase by 135% compared to the “control” poly(DSDA-TMMDA) membrane (α_{H2/CH4}=69.8 and P_{H2}=62.3 barrers) for H₂/CH₄ separation. These results demonstrate that the AlPO-14 molecular sieves in AlPO-14 membrane possessing micropores that are smaller or similar in size to CH₄ but much larger than H₂ have high H₂/CH₄ selectivity due to a molecular sieving mechanism.

The H₂/CH₄ separation performance of the “control” poly(DSDA-TMMDA) polymer membrane is far below Robeson's 1991 polymer upper bound for H₂/CH₄ separation. AlPO-14 membrane of the present invention showed significantly enhanced H₂/CH₄ separation performance that far exceeded Robeson's 1991 polymer upper bound for H₂/CH₄ separation. These results indicate that the novel voids and defects free AlPO-14 membrane of the present invention is a very promising membrane candidates for the removal of H₂ from natural gas or syngas (a gas mixture of CO₂, CO, H₂, H₂S, and COS). The improved performance of AlPO-14 membrane over the “control” poly(DSDA-TMMDA) polymer membrane is attributed to the molecular sieving mechanism of AlPO-14 molecular sieves.

TABLE 2
Pure gas permeation test results of “Control” poly(DSDA-TMMDA)
polymer membrane and AlPO-14 membrane for H₂/CH₄
separation^{a}

| | P_{H2} | ΔP_{H2} | | |
|---|---|---|---|---|
| Membrane | (Barrer) | (Barrer) | α_{H2/CH4} | Δα_{H2/CH4} |
| Poly(DSDA-TMMDA) | 62.3 | 0 | 69.8 | 0 |
| membrane | | | | |
| from Example 1 | | | | |
| AlPO-14 membrane from | 146.5 | 135% | 133.2 | 91% |
| Example 2 | | | | |

^{a}Tested at 50° C. under 690 kPa (100 psig) pure gas pressure.

1. A method of making a microporous crystalline aluminophosphate (AlPO₄) molecular sieve membrane composite, comprising the steps of:
a) providing a porous membrane support having an average pore size of at least 0.1 μm;
b) synthesizing an aqueous AlPO₄-forming gel comprising an organic structure-directing template or a mixture of two or more organic structure-directing templates;
c) aging the AlPO₄-forming gel to form an aged AlPO₄-forming gel;
d) depositing the aged AlPO₄-forming gel on at least one surface of the porous membrane support;
e) heating the porous membrane support and the aged AlPO₄-forming gel to form a layer of AlPO₄ crystals on at least one surface of the porous membrane support to produce a template-containing AlPO₄ membrane; and
f) calcining the template-containing AlPO₄ membrane to remove the organic structure-directing template or the mixture of two or more organic structure-directing templates and to form a layer of template-free microporous AlPO₄ crystals on the porous membrane support.

2. The method of claim 1 wherein a seed layer of template-containing AlPO₄ molecular sieve seeds is deposited on said porous membrane support prior to said step d).

3. The method of claim 2 wherein said template-containing AlPO₄ molecular sieve seeds have an average particle size of about 50 nm to about 1 μm.

4. The method of claim 2 wherein said template-containing AlPO₄ molecular sieves have been synthesized by a hydrothermal synthesis method or by a microwave assisted hydrothermal synthesis method.

5. The method of claim 2 wherein said template-containing AlPO₄ molecular sieve seed particles are dispersed in a solvent to prepare a colloidal solution followed by coating a layer of the colloidal solution of the template-containing AlPO₄ molecular sieve seeds on at least one surface of the porous membrane support; and then drying the layer of the template-containing AlPO₄ molecular sieve seeds to form a seed layer of AlPO₄ molecular sieve crystals on the porous membrane support.

6. The method of claim 1 after said step e), at least one additional layer of said aged AlPO₄-forming gel is deposited on said template-containing AlPO₄ membrane followed by calcination to remove said structure-directing template(s).

7. The method of claim 1 further comprising after said calcination of said template-containing AlPO₄ membrane, adding a protective layer comprising a polysiloxane, a fluoro-polymer, a thermally curable silicone rubber, a high permeability microporous polymer, a high permeability polybenzoxazole polymer, or a UV radiation curable epoxy silicone.

8. The method of claim 1 wherein said AlPO₄ molecular sieve is selected from the group consisting of AlPO-18, AlPO-14, AlPO-52, AlPO-53, AlPO-5, AlPO-34, AlPO-31, AlPO-17, AlPO-11, AlPO-41, AlPO-25, AlPO-21, AlPO-22, and mixtures thereof.

9. A method of making a microporous crystalline aluminophosphate (AlPO₄) molecular sieve membrane composite, comprising the steps of:
a) providing a porous membrane support having an average pore size of 0.1 μm or greater than 0.1 μm;
b) providing template-free AlPO₄ molecular sieve crystal particles synthesized by a hydrothermal synthesis method;
c) dispersing the template-free AlPO₄ molecular sieve crystal particles in at least one solvent to form a slurry;
d) dissolving one or two types of polymers as a binder of the template-free AlPO₄ molecular sieve particles in the slurry to form a stable polymer-bound AlPO₄ molecular sieve suspension;
e) coating at least one surface of the porous membrane support with the stable polymer-bound AlPO₄ molecular sieve suspension; and
f) drying the coated porous membrane support by applying heat to form a microporous AlPO₄ molecular sieve membrane.

10. The method of claim 9 further comprising after said step f), adding a protective layer to said microporous AlPO₄ molecular sieve membrane wherein said protective layer comprises a polysiloxane, a fluoro-polymer, a thermally curable silicone rubber, a high permeability microporous polymer, a high permeability polybenzoxazole polymer, or a UV radiation curable epoxy silicone.

11. A method for preparing a microporous aluminophosphate (AlPO₄) molecular sieve membrane comprising:
a) providing a porous membrane support having an average pore size of 0.1 μm or greater than 0.1 μm;
b) providing template-containing AlPO₄ molecular sieve seeds with an average particle size of 50 nm to 1 μm synthesized by a hydrothermal synthesis method or a microwave assisted hydrothermal synthesis method;
c) dispersing the template-containing AlPO₄ molecular sieve seed particles in a solvent to prepare a colloidal solution of the AlPO₄ molecular sieve seed particles;
d) coating a layer of the colloidal solution of the template-containing AlPO₄ molecular sieve seeds on at least one surface of the porous membrane support;
e) drying the colloidal solution layer of the template-containing AlPO₄ molecular sieve seeds on the surface of the porous membrane support to form a seed layer of AlPO₄ molecular sieve crystals on the porous membrane support;
f) synthesizing an aqueous AlPO₄-forming gel comprising an organic structure-directing template or a mixture of two or more organic structure-directing templates;
g) aging the AlPO₄-forming gel to form an aged AlPO₄-forming gel;
h) contacting the surface of the seed layer of AlPO₄ molecular sieve crystals supported on a porous membrane support with the aged AlPO₄-forming gel;
i) heating the seeded porous membrane support and the aged AlPO₄-forming gel to form a continuous second layer of AlPO₄ molecular sieve crystals on the seed layer of AlPO₄ molecular sieve crystals supported on the porous membrane support; and
j) and calcining the resulting template-containing dual layer AlPO₄ molecular sieve membrane to remove the organic structure-directing template(s) and form a dual layer template-free microporous AlPO₄ molecular sieve crystals on the porous membrane support.

12. The method of claim 11 further comprising after said step i), contacting the surface of the continuous layer of AlPO₄ molecular sieve crystals on the seed layer of AlPO₄ molecular sieve crystals supported on the porous membrane support with the aged AlPO₄-forming gel again followed by heating and repeating the contact and heating steps as desired.

13. A process for separating a mixture of gases or liquids comprising:
a) providing a microporous AlPO₄ molecular sieve membrane which is permeable to at least one gas or one liquid;
b) contacting the mixture of gases or liquids on one side of the microporous AlPO₄ molecular sieve membrane to cause said at least one gas or one liquid to permeate the microporous AlPO₄ molecular sieve membrane; and
c) removing from the opposite side of the membrane a permeate gas or liquid composition comprising a portion of said at least one gas or one liquid which permeated said membrane.

14. The process of claim 13 wherein said AlPO₄ molecular sieve membrane comprises at least one layer consisting essentially of aluminophosphate molecular sieves.

15. The process of claim 14 wherein said aluminophosphate molecular sieves are selected from the group consisting of AlPO-18, AlPO-14, AlPO-52, AlPO-53, AlPO-5, AlPO-34, AlPO-31, AlPO-17, AlPO-11, AlPO-41, AlPO-25, AlPO-21, AlPO-22, and mixtures thereof

16. A membrane comprising a layer consisting essentially of aluminophosphate molecular sieves.

17. The membrane of claim 16 wherein said aluminophosphate molecular sieves are selected from the group consisting of AlPO-18, AlPO-14, AlPO-52, AlPO-53, AlPO-5, AlPO-34, AlPO-31, AlPO-17, AlPO-11, AlPO-41, AlPO-25, AlPO-21, AlPO-22, and mixtures thereof

18. The membrane of claim 16 wherein said aluminophosphates molecular sieve is AlPO-14 or AlPO-18.

19. The membrane of claim 16 wherein said aluminophosphates molecular sieves are bound by a polymer.

20. The membrane of claim 18 wherein said polymer comprises a glassy polymer.

21. The membrane of claim 19 wherein said glassy polymer comprises polyimide, polybenzoxazole, microporous polymer, polyethersulfone or a mixture thereof.
